(19) United States
(12) Patent Application Publication
(10) Pub. No.: US 2015/0310495 A1
(43) Pub. Date: Oct. 29, 2015

(54) TECHNOLOGY AND PROCESS FOR DIGITAL, MOBILE ADVERTISING AT SCALE

(71) Applicant: Mobile Majority, Santa Monica, CA (US)

(72) Inventors: Sam GOLDBERG, Santa Monica, CA (US); Rob EMRICH, Santa Monica, CA (US); Sam KIM, Venice, CA (US); Marcelo WIERMANN, Santa Monica, CA (US); Miguel MORALES, Los Angeles, CA (US)

(21) Appl. No.: 14/694,920

(22) Filed: Apr. 23, 2015

Related U.S. Application Data
(60) Provisional application No. 61/983,207, filed on Apr. 23, 2014.

(51) Int. Cl. G06Q 30/02

(52) U.S. Cl. CPC G06Q 30/0267; G06Q 30/0242; G06Q 30/0244

(57) ABSTRACT

The system delivers a single unit that includes the software that makes up an ad unit as well as a container for that ad unit that protects it from the harsh environments of ad network SDKs. The system allows for a container of other software to be tested in these various environments instead of sending the Ad Tag directly into the SDK. This allows Ad Tag units to display reliably within a container that is certified once instead of needing to certify each occurrence of the ad unit.

This patent application claims priority to U.S. Provisional Patent Application Ser. No. 61/983,207 filed on Apr. 23, 2014, which is incorporated by reference herein in its entirety.

BACKGROUND OF THE SYSTEM

1. Field of the System

The present system relates generally to a mobile device implemented process providing an advertising delivery mechanism to deliver quality ads at scale in the digital ecosystem.

2. Background

Most mobile ads today are delivered via a wide range of technologies and technologies that are mostly hostile to the ads being displayed—specifically, the hostile technologies do not follow conventions or standardized specifications. Often these various technologies are not well integrated, nor do they perform well across different types of devices or operating systems.

A typical advertising technology serves an Ad Tag directly into a third party software development kit (“SDK”). An Ad tag is a piece of JavaScript (a series of commands) that injects information into the context of the ad and loads resources that are needed for the ad to be displayed. Ad tags then call macros (device IDs, device operation system, time stamp, impression ID, etc). Ad tags also control the initiation of the Ad. Ads themselves are (the visual part) is comprised of code from languages JavaScript, CSS, HTML and others.

A problem in current environments is that there are a number of 3rd party SDK environments. Each SDK environment interprets the ad tags differently. This causes ad to be displayed with bugs, incorrectly, or not at all. For example, the ad may not crop properly to the size of the screen, resulting in missing content, text, graphics and the like. In other cases, the ad will display in a distorted ratio, causing unrealistic looking images. Another problem may be the introduction of bugs that affect the playback of the ad, introducing stalls and interruptions to the ad. Current ads include static images, text, and video, as well as software based ads that provide a richer, more interactive experience. The complexity of current ads (particularly software based ads) is overwhelming the ability of current third party SDK environments. Currently, in order for an ad unit to display reliable and correctly, an advertiser must create different Ad tags for each environment and even different ad tags for each type of device (device that the end user may own, like an iPhone, Samsung Galaxy, HTC phone, etc)

When an ad does not display correctly, it is less likely to be viewed at all, and less likely to trigger a response. These problems preclude advertisers from reliably delivering large quantities of ads with confidence knowing that the ads will be viewed by consumers in the same framework as the ads are intended to be viewed.

The failed presentation of ads has an impact on ad delivery data, tracking, accountability and financial accounting. Historically, many digital ads were sold on a display/impression basis, so the seller would get paid as long as there was evidence that a tracking pixel located in the image was fired, indicating that at least one pixel (the tracking pixel) was displayed to the end user. This method of tracking has no component to evaluate whether the ad was actually visible or bug-free to the end user.

Selling digital ads on a performance basis makes it necessary for an ad to be shown and rendered. Moreover, advertisers are demanding that their ads, even if not sold on performance basis, be viewed by a consumer. In addition to digital ads that may have bugs or loading problems that preclude proper viewing by the end user, there are also cases of digital fraud where a publisher will find ways to have the tracking technology acknowledge an ad was shown, when in fact, the end user was not able to see the ad properly. Fraudulent ads will never convert, so such a mechanic is detrimental for performance sellers.

### SUMMARY

The system delivers a single unit that includes the software that makes up an ad unit as well as a container for that ad unit that protects it from the harsh environments of ad network SDKs. The system allows for a container of other software to be tested in these various environments instead of sending the Ad Tag directly into the SDK. This allows Ad Tag units to display reliably within a container that is certified once instead of certifying each occurrence of the ad unit.

Third party ad trackers only evaluate and report if an impression has been delivered to the consumer—but this could be a blank screen, otherwise a product of fraud, cached and not displayed (sometimes referred to as “pre-cached”) or a screen that has not fully loaded the ad. The present system allows for advertisers to confidently deliver ads across platforms and different types of devices because the system will determine at scale whether the ads are being properly shown to consumers and factor that information (or score) into a bid request. The system thus allows a bidding system where both price and quality are used to determine value, rather than price alone.

The present system provides technology establishes a live communication with the ecosystem in which an ad appears. The present system determines if an ad has been displayed at all or correctly. The system can generate a score based on a number of factors, including, but not limited to visibility, placement, and timing, connection speed, operating system, IP address, user agent, as well as load speed and percentage of assets loaded. The score can be used to determine pricing for the ad. The system includes fraud prevention mechanisms as well as advanced billing metrics.

### BRIEF DESCRIPTION OF THE DRAWINGS

FIG. 1 illustrates an embodiment of the system.

FIG. 2 is a flow diagram illustrating the operation of an embodiment of the system in preparing an ad.

FIG. 3 is a flow diagram illustrating the playback of an ad in an embodiment of the system.

FIG. 4 illustrates the generation of an Ad Score in one embodiment of the system.

FIG. 5 is a flow diagram illustrating the use of statistical models to direct ads.

FIG. 6 is a block diagram illustrating one embodiment of the system.

FIG. 7 is a flow diagram illustrating automatic user feedback detection.

FIG. 8 is a flow diagram illustrating contextualization of an ad in an embodiment of the system.

FIG. 9 is an example architecture of an embodiment of the system.

FIG. 10 is an example computer environment for implementing the system.

### DETAILED DESCRIPTION

The present system now will be described more fully hereinafter with reference to the accompanying drawings, which are intended to be read in conjunction with both this summary, the detailed description and any preferred and/or particular embodiments specifically discussed or otherwise disclosed. This system may, however, be embodied in many different forms and should not be construed as limited to the embodiments set forth herein; rather, these embodiments are provided by way of illustration only and so that this disclosure will be thorough, complete and will fully convey the full scope of the system to those skilled in the art.

The present system provides tools that are used to build rich media and other types of ads without having to address the issues of functionality and quality in different 3rd party SDK environments. The system can be used to build ad units dynamically, both visually and technically, by referencing information from the device on which the ad is appearing as well as other data stored on one or more servers. The system allows data collection that can be used to optimize the effectiveness of the ad unit. The system also allows for the use of data to better target the ads. This is done because the system recognizes, in advance of placing an ad, if the device owned by an end user is a match to the target demographic for the advertiser.

The system implements low level facilities for event logging. This includes automatic event logging such as impression of ads and transition between pages within an ad. It also includes manual event logging such as a form submission that the ad developer inserts into the present system's container. The system works as an adapter layer between the ad and the underlying container, so the ad has access to MRAID and VPAID events.

### Container

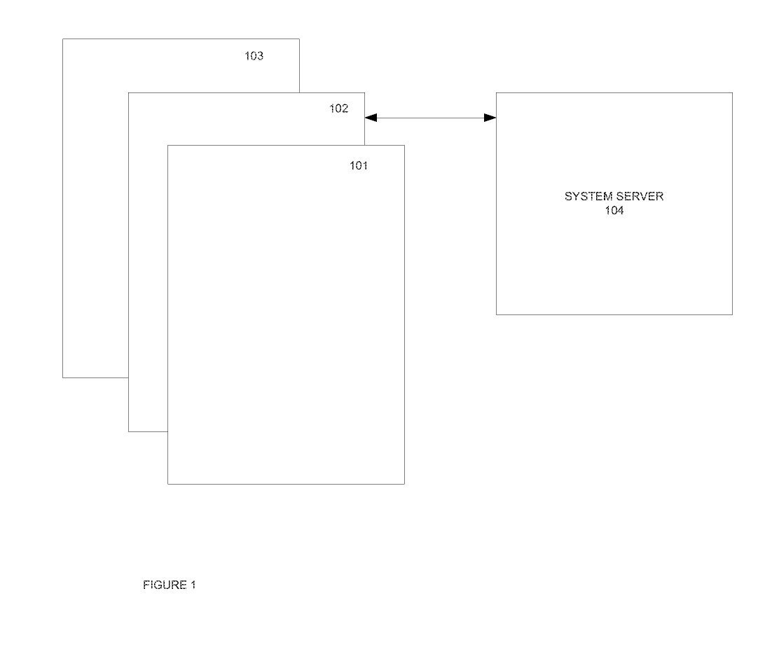

The system provides a container for an ad that allows it to be run reliably on a plurality of SDKs. FIG. 1 illustrates an embodiment of the container in one embodiment of the system. The container can be thought of symbolically as a series of layers. The Ad Creative 101 is the part of the ad that is viewed by the consumer/user of a mobile device. This includes elements like the text, graphics, video, audio, and software application that may be embedded with the ad.

The Ad Container 102 is a container that includes the necessary libraries and instructions that control the functionality of the ad. This container 102 controls how a consumer engages with the ad unit. In one embodiment, the Ad Container 102 is embodied as JavaSript. However, any other suitable language can be used, including operating system independent scripting languages, write once, run anywhere languages, bytecode based systems, or other cross-platform systems that can use virtual machines. In one embodiment, the ad may include a game for the consumer to play. The present system uses a game container with 3-D acceleration/3-D graphics with surround sound. This allows access video cards from a browser that enables 3-D content creation. This enables dynamic creation of 3-D ad unit.

The Ad Framework 103 is a layer that recognizes the form factor, operating system, and device type of the mobile device on which the ad is to play in order to effectively deliver an appropriate sized and functioning ad unit.

In the embodiment of FIG. 1, one or more system servers can interact with the JavaScript Container 102. Information flows between the server(s) 104 and the container 102. Information from the consumer interacting with the ad is obtained by the JavaScript Container 102 and is then sent to server 104 as data. This information may include, for example, information that is used to optimize future ad campaigns and ad deliveries to that respective consumer. Information from Server 104 to JavaScript Container 102 includes data about the ad unit; for example information such as targeting parameters (to preclude certain consumers from receiving the ad unit, or in the alternative, actively present the ad unit to only certain consumers). The system can dynamically modify the ad, the ad content, and other aspects of the ad based on geolocation data, user, user device, contextual information, physical distance from a retailer, and the like.

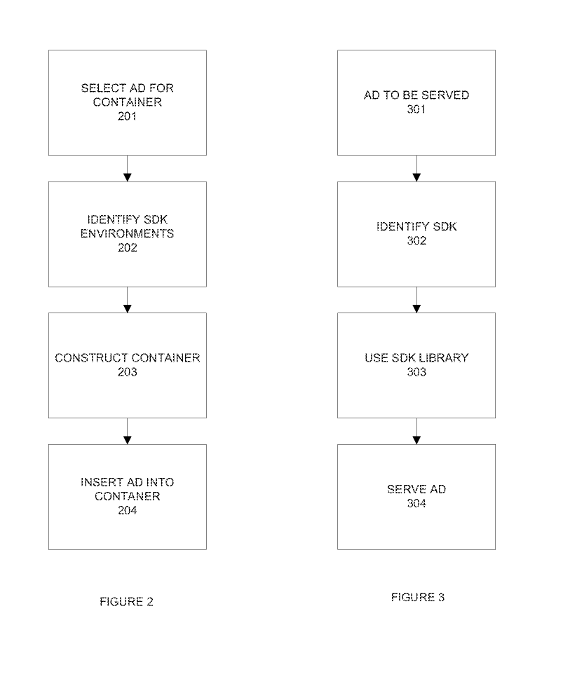

FIG. 2 is a flow diagram illustrating the creation of a container for an ad in an embodiment of the system. At step 201 an ad is selected for insertion into a container. At step 202 the SDKs on which the ad will run are determined. At step 203 the system constructs a container that will provide accurate display of the selected ad in each of the SDK environments. The construction of the container at step 203 includes providing a Library for the ads, for the creative layer and the ADEX (ad executable). The container enables the system to define the size, location (e.g. above fold, below fold) and other display parameters

Some of the attributes of a container include, but are not limited to, position (x, y), width, height, pixel depth, pixel ratio, device pixel density, click and touch events, size changes, MRAID (Mobile Rich Media Ad Interface Definitions) provided attributes, and the like. In one embodiment, such attributes would include some or all of what is referred to as a “device fingerprint” that provides information about the capability of the consumer mobile device. Fingerprinting is the process of mapping device ID, cookie ID based on user, agent, IP address and timestamp. In some cases, the device ID is not available. If a device does not provide a device ID, the system provides a fingerprinting fall back mechanism that allows the system to match a device whether looking at a cookie or the device ID. The system can generate a device ID by fingerprinting the browser/device. The system gathers all the parameters of its environment, and creates a signature based on these parameters (e.g. IP, screen size, etc). Based on pixel density or how a video renders, the fingerprinting can determine the type of device and associate with a unique identifier in the system.

The Library includes all of the commands that are necessary for the proper display of the ad in a particular SDK and/or mobile platform. The Library includes functions to identify, measure, track and communicate to an API parameters needed to detect fraud, malfunctioning environments, placements with integration issues or other conditions that have hitherto described anomalous viewing situations. Those viewing situations include but are not limited to advertisement stacking, pixel cramming, off-the-screen displaying, pre-caching, and JavaScript errors. At step 204 the system inserts the ad into the container and the container is ready to be delivered.

The delivery of an ad is illustrated in the flow diagram of FIG. 3. At step 301 the ad to be served is identified. At step 302 the SDK of the mobile platform on which the ad is to be displayed is identified. At step 303 the library in the container for that SDK is used to identify the procedures and calls for proper display of the ad. At step 304 the ad is served and displayed on the mobile device.

Ad Score and App Reputation Score

The system includes a process for generating an Ad Score that represents accountable metrics associated with the display of an ad and consumer interaction with the ad. The system also can generate an App Reputation Score that represents the successful deployment of the ad on a particular platform and the quality of the impression on the platform.

The system creates an Ad Score by detecting and ranking metrics associated with the display and performance of the ad. These two sources are combined to result in an Ad Score. The Ad Score is used in a number of ways, including ranking the effectiveness of the presentation of the ad, consumer interaction with the ad, and can be used to establish pricing for the ad in an effective manner. It should be noted that the generation of an Ad Score is independent of whether the ad is in a container as described above. Any ad presentation system that can return information about the display of the ad and/or user experience can be used to generate an Ad Score and utilize it for serving ads as described herein.

FIG. 4 illustrates one example of the Ad Scoring process of the system. The illustration of FIG. 4 is for purposes of example only, and other metrics and parameters can be used to generate an Ad Score in the system. When an ad is run on a consumer device, the system analyzes metrics associated with the ad to generate an Environment Score 401 and an Ad Unit Score 402. These scores are combined to form an Ad Score 403. In one embodiment, the Environment Score is generated from metrics associated with the look and display of the ad. For example, the metrics could include whether the ad was stretched or cropped, whether there were stacked images, and if there were unsuitable container dimensions (e.g. 0×0 or 1×1 pixels). The Environment Score 401 can comprise these metrics and/or other metrics as well. The absence of negative environment metrics increases the score of an ad.

The Ad Unit score 402 represents performance related features of the ad. For example, in one embodiment the Ad Unit Score 402 includes a rating for the load time of the ad (e.g. a fast load time equals a higher score), if the ad is bug free on the mobile platform, device compatibility, legibility of the ad, audio playback, video playback, software execution, and the like. The Ad Unit Score 402 may include these and other factors to generate the Ad Unit Score 402. The Ad Score can then be used to identify different tiers of ads (e.g. premium, non-premium, and the like).

The ad container includes mechanisms to detect and measure the metrics that are used to generate the Ad Score. The container includes instrumentation necessary for the evaluation of whether an ad is properly loaded and available for viewing by an end user. The metrics used to generate the Ad Score include, but are not limited to: page load time, load completion, percent of assets loaded, JavaScript errors, container dimensions (different libraries/techniques are used to detect the dimensions, so the system can reliably extract the dimensions and fit the ad to the screen size), and the like.

The combination of these scores results in the Ad Score 403. In one embodiment the values from the metrics are such that the range of scores is from zero to one hundred, with a lower score indicating a low quality ad and a higher score indicating a high quality ad.

The App Reputation score is a value that is derived from determining elements of the environment an ad unit is displayed in. Some of the metrics used to generate the App Reputation Score include the percent of ad units that are shown in the correct size factor on the platform, whether the ad is shown at all, and user interaction. The present system allows for the most critical data to be used to determine the value of an ad impression in an RTB or mediated system. The App Reputation Score can be used by the system to make real time decisions through machine learning on the value of ad, where to place an ad, how many ads to deliver, etc.

The system can collect data and record events through via JSON or standard pixels or URLs. These events are recorded on system servers and used to determine the ad delivery scoring mechanism. HTTP calls via JSON or pixel URLs.

### Dynamic Ad Serving and Bidding

The Ad Scores and App Reputation scores can be fed back to an ad server which can make a decision on whether to display an ad or not. This score of environmental quality, along with price, can be used within a real time bidding system to inform a better overall decision on the actual value of the ad unit.

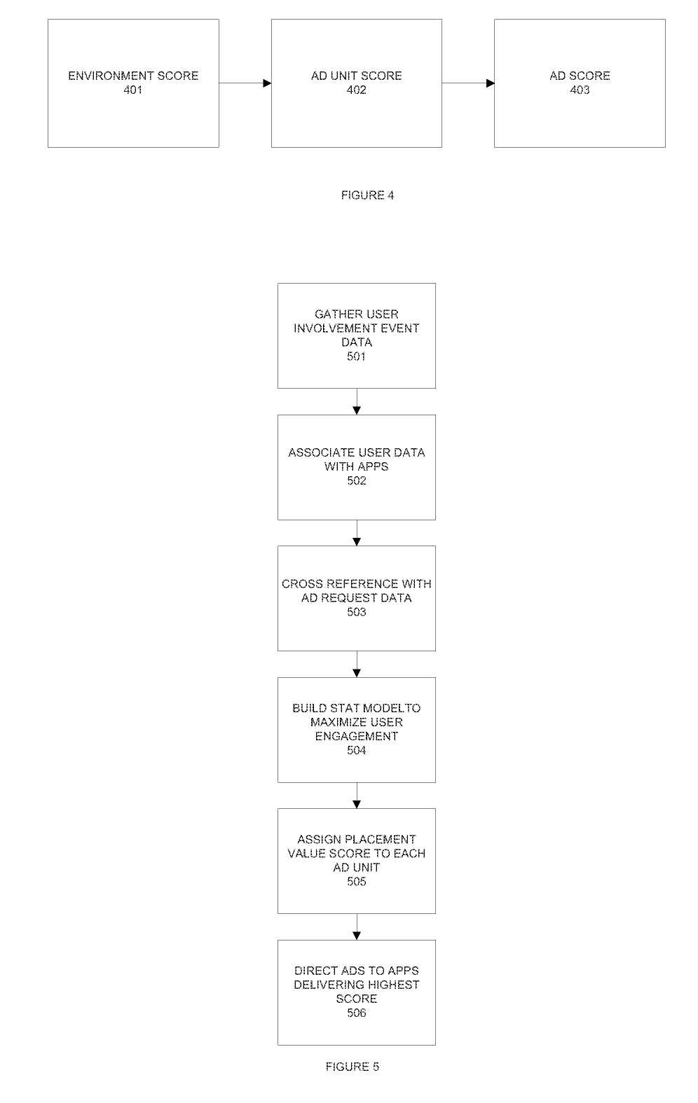

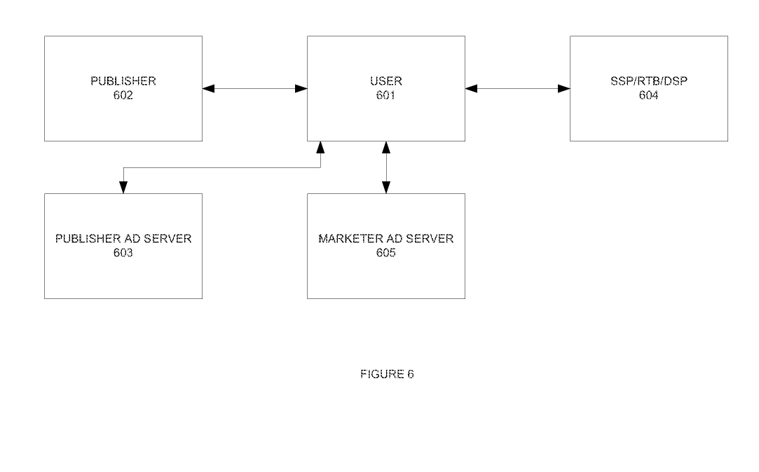

FIG. 5 is a flow diagram illustrating the operation of the dynamic ad serving and bidding in one embodiment. At step 501, the system gathers user behavior event data from ads including, but not limited to impressions, clicks, form submissions, video watches, game-play events, and the like. At step 502 this user interaction data is associated with apps and platforms so that the user interaction value of the ad can be determined in a plurality of environments. This association can be accomplished by a histogram, via scoring algorithms, or by some other statistical approach. The result of this association is an App Reputation Value for each ad unit on each app.

At step 503 the system cross references App Reputation data with ad request data from real-time-bidding platforms (“RTB”) or directly from third party SDKs or server-to-server systems. At step 504, using this raw data, the system builds a statistical model designed to maximize user engagement for each particular ad unit. At step 505 the system can assign a Placement Value score to each ad unit for a particular consumer platform. In some iterations of the system, this Placement Value Score (a statistical model designed to maximize user engagement for a particular ad unit) directs ads in a dynamic way to the apps/websites that are delivering the highest “score”. In doing so, this defines what app is “premium” (or the most likely to receive engagement from end users for a particular ad) for a particular ad campaign.

For scores above a certain metric, then the present system can be inserted into a programmatic buying template to only serve ads to apps that have App Reputation Scores above a particular value in a dynamic way for each new ad campaign. In some iterations of the present system, more ads are physically displayed on apps that have an App Reputation Score above a determined threshold. In some iterations of the present system, no ads are displayed at all in apps that have an App Reputation Score below a determined threshold. The scoring mechanic can also be incorporated into dynamic pricing structures for advertisers where the more premium placements are priced higher.

### Ad Campaign Management

The ad containers of the system include macros to collect, scrape, and/or retrieve data that is provided back the system to be used in the dynamic bidding process. Some of the data includes, but is not limited to, ad load time, percent of assets loaded, viewing time, user engagement (actively interacting with the ad via clicks, data entry, and the like), activation rate, click-through to advertiser site, purchase, and the like. This allows the system to operate more effectively and to take advantage of an integrated ad server ecosystem.

In the current art, mobile ad serving involves demand side platforms (DSPs), supply side platforms (SSPs) and Ad Exchanges in a real time bidding (RTB) ecosystem. In operation, when a consumer navigates to a publisher website, the website sends code to the browser to direct it to where it can get content for the site and how to format the content. Part of that code includes an ad tag that points to an RTB enabled SSP.

The user (through the user browser) calls the SSP, which reads (or already has) a user cookie that provides relevant information that can provide the parameters for an ad auction. The SSP starts the auction by requesting bids from a plurality of third party DSPs, who use the SSP cookie and other user information to value the impression and generate a bid to serve an ad. The bids are returned to the SSP along with an ad direct should the bid be a winning bid. The SSP picks the winning bid and passes the redirect back to the user and the ad is served from the marketers ad server. One disadvantage of the prior art system is timing. The directs and redirects (I/O operations) are the most time intensive part of the process. The processing at a DSP or SSP can be accomplished relatively quickly, however, the I/O latency can slow down the process to the point where a bid might not be made in time (e.g. in an available window to place the bid of up to 140 msec in many environments).

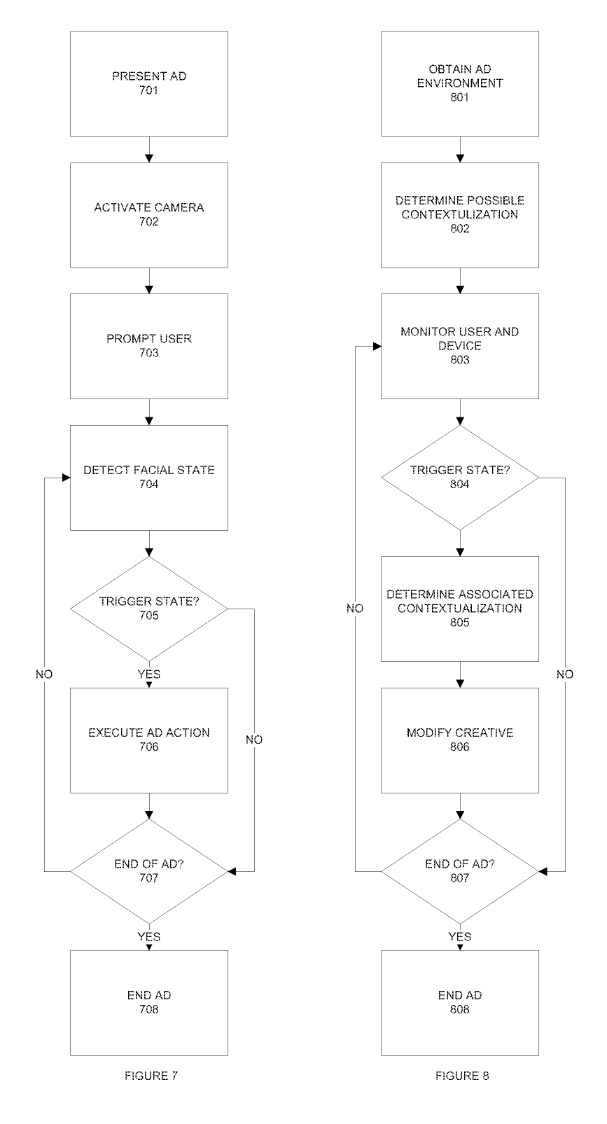

The present system provides an integrated ad serving ecosystem as shown in FIG. 6. A user 601 interacts with a Publisher website 602. The publisher ad server 603 will serve an ad tag back to the user browser that points to the RTB 604. The SSP/RTB of the system includes its own RSPs. The integration of an RSP with the bidder eliminates the I/O calls that can slow down the bidding process. The system can perform bidding analysis in under 15 msec, well under the 140 msec available time window requirement.

In addition, the system takes advantage of the dynamic campaign management. The system uses pre-bid intelligence to already know which ads are best to serve in a particular case, due to knowledge of App Reputation Scores.

### Fraud Prevention

Some real-time-bidding platforms use an ad tag that allows a hacker to generate the codes that these bidders send back to the advertiser saying that the ad has been served. This would result in a false indication of a served ad, leading to a financial event that is not justified.

In the system a served ad includes an injected request ID. When an action is received, the creative has to send the request ID (the system knows the request ID is valid because the system requested it).

In some cases, servers may stack multiple ads on top of each other. The system container includes procedures to detect such fraud, and uses this information as part of the App Reputation Score.

The system also can detect the difference between a pre-cache mode and a cache mode to determine if the rendering is the actual ad impressions that is delivered to a consumer/user. The present system may send a cookie or a local storage device/mechanism with the container. If the cookie gets activated again, then the system is not in pre-cache mode. If in pre-cache mode, then flagged, a pixel is not fired because it is not a “real” impression. This also helps determine if the system has a bug for this delivery channel because it does not leave pre-cache mode.

The system can also detect if an ad is below the fold or above the fold and not in the field of view. The field of view being the viewable screen on a mobile device where an end user can actually see images, text, and the like.

### Ad Response Feedback

The system provides a method to measure emotional response in real time in order to optimize the ad units effectiveness as well as even bill based on receiving the desired emotional response. An additional problem with advertising today is that analyzing consumer enjoyment/acceptance of advertising is difficult to evaluate. The present system combines statistical metrics such as click-through rates and engagement rates with survey information. These elements provide to marketers a powerful new tool by allowing ads to continue their presentation if the survey data indicates satisfaction with the ad.

In one embodiment, this is accomplished by using the mobile device camera and facial recognition technology to record specific facial inputs. The system looks for specific facial inputs that represent different user states. Based on the user states, some action will be taken with the ad. For example, in one embodiment, If the facial inputs equate to acceptance/happiness/enjoyment, then the ad continues. If the facial inputs does not equate to acceptance, then the ad disappears. By this process, marketing can now combine the elusive emotional component of advertising, on a real time basis, with the statistical component that people use to determine advertising campaign success (engagement rates, etc).

In other embodiments, the ad may be dynamically modified on the fly in response to user facial gestures and expressions. Such modification may include change to the Ad Creative including, but not limited to, color changes, size changes, content selection, shorter or longer playback, calls to action, and the like.

An example of this process is illustrated in the flow diagram of FIG. 7. At step 701 an Ad unit is presented to a user. At step 702 the camera on the user device is activated. At step 703, in one embodiment, the user may be prompted by the ad to smile or make some other facial gesture to indicate interest. This step may be optional if desired. the system may simply monitor the users face to detect facial expressions and gestures. At step 704 the system detects the facial state of the user.

At decision block 705 it is determined if the facial state of the user is a trigger facial state that will result in some action being taken with the ad. This is accomplished by comparing the detected facial state to a look up table of possible facial expressions. If so, the system proceeds to step 706 and some action is taken with the ad. This could be simply continuing the ad if the user facial expression indicates interest. In other cases, it could be causing the ad to dynamically change based on the user facial expression. The action taken is one that has been pre-associated with one or more facial expressions.

At decision block 707 it is determined if the end of the ad has been reached. If not, the system returns to decision block 704 to detect and monitor the facial state of the user. At each pass through this loop, the facial expression of the user is monitored and detected and the ad may be repeatedly and dynamically modified as appropriate to maximize the effectiveness of the ad. In one embodiment, the system utilizes a state machine that tracks expressions and provides branching to actions based on other facial expressions that may be detected. This may be done to help guide a user through one or more states to maximize effectiveness of the ad.

If the end of the ad has been reached at block 707, or if the desired state of the user is not present at 705, the ad is ended at step 708.

### Contextualization

The use of facial detection to modify an ad dynamically is one example of ad “contextualization” that allows the ad to react to user and device events. Based on the app/site on which the ad is rendered, the present system dynamically generates information from the server to make the ad native/contextualized for the app/website. This means ads are built dynamically and on the fly and appear to be personalized as well as part of an app or website. This results in an increase in effectiveness.

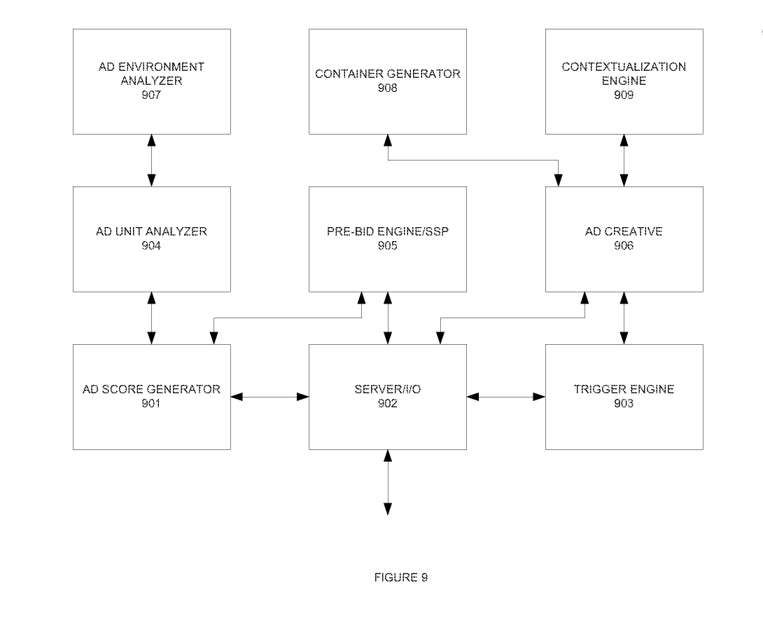

The contextualization of the ad is initially determined by the capabilities of the system on which the ad is displayed. FIG. 8 is a flow diagram illustrating the operation of the system in one embodiment of the contextualization process. At step 801 the app/device/website information is obtained. At step 802 it is determined if and at what level contextualization is possible for the app/device/website combination. For example, some environments may be able to take advantage of all possible dynamic ad modification operations while others may be limited to some subset of such actions.

At step 803 the system checks for a user action that could be a trigger for contextualization of the ad. The user triggers could be one or more of a number of actions related to the device on which the ad is displayed. For example, the trigger could be squeezing of the device, shaking of the device, orientation of the device, movement of the device, eye tracking, gestures on the screen, and the like. The triggers could be in response to calls for action that are part of the ad creative, or made spontaneously by the user.

At decision block 804 it is determined if a trigger is found. If so, the system proceeds to step 805 to determine the contextualization that is to take place in response to the trigger. At step 806 the ad is contextualized based on the trigger event. The contextualization could be determined from a look-up table associated with the trigger or it could be based on a state machine associated with a progression of triggers.

After step 806, or if no trigger is found at block 804, the system proceeds to decision block 807 to determine if the end of the ad has been reached. If so, the system proceeds to step 808 and the ad ends. If not, the system returns to step 803 to check monitor user actions.

### Ad Presentation

The system can provide a richer ad experience because of the ability of the system and container to interact with the mobile device of the consumer. For example, the system could provide an ad that includes coordinated tactile feedback by activating the vibration mode of the mobile device and coordinating it with ad presentation and/or user interaction.

As noted above, the system can provide access to a camera on the mobile device. This allows the system to create a “selfie-ad”. The present system enables the phone's camera to take a picture of the end user and insert it into the ad unit being displayed on the consumer device. A region of the ad is reserved for the selfie and once taken, the selfie is automatically added to the reserved area so that the user's own face becomes part of the ad experience. In one embodiment, the user will opt-in to allow the camera to be used.

Another advantage of the system is the ability, using the camera, to detect where the user is looking in the ad. Similar to correlating the mouse position in browsers, the present system enables the phone's camera to evaluate what part of the ad is being viewed by the end user. Based on this feedback from the phone's camera, the ad unit software adjusts to present content in line with the end user's viewing focus. Data from these ads can then create a heat-map of the ad unit to optimize future ads. The system then can optimize for app reputation, user interaction, as well as visual hot spots. The resulting dynamic feedback loop allows the fine tuning of ads for maximum effect, even during a campaign.

FIG. 9 is an example embodiment of the system. The system includes Server I/O 902 that provides communication between the system and ad servers, user devices, publishers, DSPs, SSPs, RTBs, and the like. Information from the I/O can be provided to the Ad Score generator 901, Trigger Engine 903, Pre-Bid engine 905, and Ad creative 906. The Ad Score generator 901 is in communication with Ad Unit Analyzer 904, and Ad Environment Analyzer 907. These units calculate and store Ad Environment scores and Ad Unit scores that are used to generate an Ad Score.

The Container Generator 908 is used to generate a container for an ad creative and is provide to the Ad Creative 906 so that Ad packages can be created and provide via I/O to users and devices. The Trigger Engine 903 can be used to accept and analyze user and device events to provide appropriate contextualization of ads from Contextualization Engine 909 via Ad Creative 905.

### Example Computer Environment

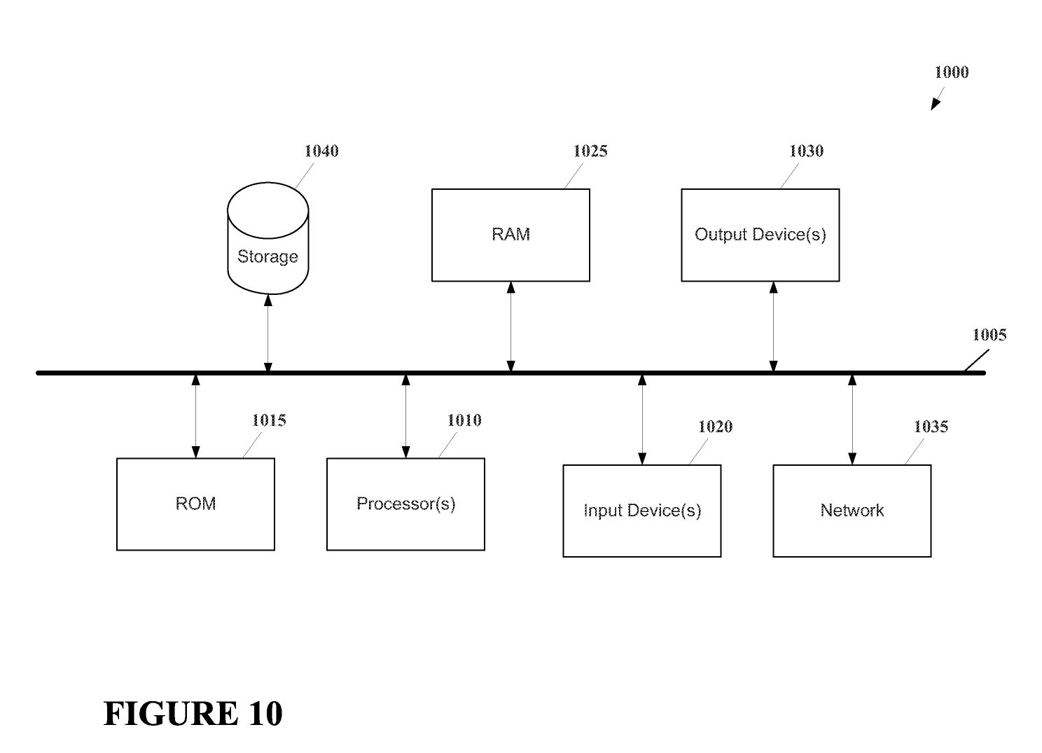

FIG. 10 illustrates an exemplary electronic system 1000 that may implement the interactive activity service. The electronic system includes various types of machine readable media and interfaces. The electronic system includes a bus 1005, processors 1010, read only memory (ROM) 1015, input device(s) 1020, random access memory 1025), output device(s) 1030, a network component 1035, and a permanent storage device 1040. The electronic system include a computer program product including the machine readable media.

The bus 1005 the communicatively connects the internal devices and/or components of the electronic system. For instance, the bus 1005 communicatively connects the processor(s) 1010 with the ROM 1015, the RAM 1025, and the permanent storage 1040. The processor(s) 1010 retrieve instructions from the memory units to execute processes of the invention.

The ROM 1015 stores static instructions needed by the processor(s) 1010 and other components of the electronic system. The ROM may store the instructions necessary for the processor to execute the web server, web application, or other web services. The permanent storage 1040 is a non-volatile memory that stores instructions and data when the electronic system 1000 is on or off. The permanent storage 1040 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 1025 is a volatile read/write memory. The RAM 1025 stores instructions needed by the processor(s) 1010 at runtime. The bus 1005 also connects input and output devices 1020 and 1030. The input devices enable the user to communicate information and select commands to the computer system. The input devices 1020 may be a keyboard or a pointing device such as a mouse. The input devices 1020 may also be a touch screen display capable of receiving touch interactions. The output device(s) 1030 display images generated by the computer system. The output devices may include printers or display devices such as monitors.

The bus 1005 also couples the electronic system to a network 1035. The electronic system may be part of a local area network (LAN), a wide area network (WAN), the Internet, or an Intranet by using a network interface. The web service may be provided to the user through a web client, which receives information transmitted on the network 1035 by the electronic system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

While the present system has been described above in terms of specific embodiments, it is to be understood that the system is not limited to these disclosed embodiments. Upon reading the teachings of this disclosure many modifications and other embodiments of the system will come to mind of those skilled in the art to which this system pertains, and which are intended to be and are covered by both this disclosure and the appended claims. It is indeed intended that the scope of the system should be determined by proper interpretation and construction of the appended claims and their legal equivalents, as understood by those of skill in the art relying upon the disclosure in this specification and the attached drawings.

What is claimed is:

1. A method for delivering an ad to a mobile device comprising:
generating an Ad Creative comprising the display elements of an ad to be displayed on the mobile device;
generating an Ad Container that includes a Library of commands to display the Ad Creative on the mobile device;
transmitting the Ad Creative and the Ad Container to the mobile device for display.

2. The method of claim 1 wherein the Library of commands comprises commands for properly displaying the Ad Creative on a plurality of SDK environments.

3. The method of claim 1 wherein the Ad Container includes tools for collecting user experience data associated with the display of the ad on the mobile device.

4. The method of claim 3 further including generating an Environment Score associated with the display of the ad on the mobile device.

5. The method of claim 4 further including generating an Ad Unit Score associated with the performance of the ad on the mobile device.

6. The method of claim 5 further including the step of generating an Ad Score based at least in part on the Environment Score and the Ad Unit Score.

7. The method of claim 6 wherein a price charged for the ad is based at least in part on the Ad Score.

8. The method of claim 7 wherein an Ad Creative is only served on a mobile display having an Ad Score above a threshold.

9. The method of claim 1 further including activating a camera on the mobile device to detect facial response of a user observing the display of the ad.

10. The method of claim 9 wherein the ad creative is modified in response the user facial response.

11. The method of claim 1 wherein user actions associated with the mobile device are detected.

12. The method of claim 11 wherein the Ad Creative is modified dynamically in response to detected user actions.

13. A method of serving an ad to a mobile device comprising:
collecting user experience data associated with the display of the ad on the mobile device;
generating an Ad Score based on the collected data;
serving the ad based when the Ad Score is above a threshold.

14. The method of claim 13 wherein a price of the ad is based on the Ad Score.
